(19) United States
(12) Patent Application Publication
(10) Pub. No.: US 2026/0254073 A1
(43) Pub. Date: Aug. 27, 2026

(54) ENERGY STORAGE CELL AND PRODUCTION METHOD

(71) Applicant: VARTA Microbattery GmbH, Ellwangen Jagst (DE)

(72) Inventors: Edward PYTLIK, Ellwangen (DE); Dominik KIENINGER, Rainau (DE); David ENSLING, Ellwangen (DE)

(21) Appl. No.: 18/860,710

(22) PCT Filed: May 1, 2023
(86) PCT No.: PCT/EP2023/061426

§ 371 Date: Oct. 28, 2024

(30) Foreign Application Priority Data
Apr. 29, 2022 (EP) 22170793.8

(51) Int. Cl. H01M 50/593; H01M 10/0525; H01M 10/0587; H01M 50/107; H01M 50/152; H01M 50/171; H01M 50/184; H01M 50/536; H01M 50/595

(52) U.S. Cl. CPC H01M 50/593; H01M 10/0525; H01M 10/0587; H01M 50/107; H01M 50/152; H01M 50/171; H01M 50/184; H01M 50/536; H01M 50/595

(57) ABSTRACT

An energy storage cell includes an electrode-separator assembly with the sequence anode/separator/cathode. The anode is ribbon-shaped and includes a ribbon-shaped anode current collector with a first longitudinal edge, a second longitudinal edge parallel thereto, a main region loaded with a layer of negative electrode material, and a free edge strip extending along the first longitudinal edge. The cathode is ribbon-shaped and includes a ribbon-shaped cathode current collector with a first longitudinal edge, a second longitudinal edge parallel thereto, a main region loaded with a layer of positive electrode material, and a free edge strip extending along the first longitudinal edge and being not loaded with the positive electrode material. The electrode-separator assembly is in the form of a cylindrical winding with a first terminal end face bounded by a circumferential edge and a second terminal end face bounded by a circumferential edge and a winding shell located therebetween.

### CROSS REFERENCE TO RELATED APPLICATIONS

This application is a U.S. National Phase application under 35 U.S.C. § 371 of International Application No. PCT/EP 2023/061426, filed on May 1, 2023, and claims benefit to European Patent Application No. EP 22170793.8, filed on Apr. 29, 2022. The International Application was published in German on Nov. 2, 2023 as WO/ 2023/209247 A2 under PCT Article 21(2).

### FIELD

The present disclosure relates to an energy storage cell and a method of manufacturing an energy storage cell.

### BACKGROUND

Electrochemical energy storage elements can convert stored chemical energy into electrical energy through virtue of a redox-reaction. The simplest form of an electrochemical energy storage element is the electrochemical cell. It comprises a positive and a negative electrode, which are separated from each other by a separator. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is made possible by an ion-conducting electrolyte.

If the discharge is reversible, i.e. it is possible to reverse the conversion of chemical energy into electrical energy during discharge and charge the cell again, this is said to be a secondary cell. The common designation of the negative electrode as the anode and the designation of the positive electrode as the cathode in secondary cells refers to the discharge function of the electrochemical cell.

Secondary lithium-ion cells are used as energy storage elements for many applications today, as they can provide high currents and are characterized by a comparatively high energy density. They are based on the use of lithium, which can migrate back and forth between the electrodes of the cell in the form of ions. The negative electrode and the positive electrode of a lithium-ion cell are generally formed by so-called composite electrodes, which comprise electrochemically inactive components as well as electrochemically active components.

In principle, all materials that can absorb and release lithium ions can be used as electrochemically active components (active materials) for secondary lithium-ion cells. For example, carbon-based particles such as graphitic carbon are used for the negative electrode. Active materials for the positive electrode can be, for example, lithium cobalt oxide (LiCoO₂), lithium manganese oxide (LiMn₂O₄), lithium iron phosphate (LiFePO₄) or derivatives thereof. The electrochemically active materials are generally contained in the electrodes in particle form.

As electrochemically inactive components, the composite electrodes generally comprise a flat and/or ribbon-shaped current collector, for example a metallic foil, which serves as a carrier for the respective active material. The current collector for the negative electrode (anode current collector) can be made of copper or nickel, for example, and the current collector for the positive electrode (cathode current collector) can be made of aluminum, for example. Furthermore, the electrodes can comprise an electrode binder (e.g. polyvinylidene fluoride (PVDF) or another polymer, for example carboxymethyl cellulose), conductivity-improving additives and other additives as electrochemically inactive components. The electrode binder ensures the mechanical stability of the electrodes and often also the adhesion of the active material to the current collectors.

As electrolytes, lithium-ion cells generally comprise solutions of lithium salts such as lithium hexafluorophosphate (LiPF₆) in organic solvents (e.g. ethers and esters of carbonic acid).

When manufacturing a lithium-ion cell, the composite electrodes are combined with one or more separators to form an electrode-separator assembly in which the electrodes are connected to each other via the separator. The electrodes and separators are connected to each other with or without pressure, possibly also by lamination or bonding. The basic functionality of the cell can then be established by impregnating the assembly with the electrolyte.

In many embodiments, the electrode-separator assembly is formed in the form of a winding or processed into a winding. In the first case, for example, a ribbon-shaped positive electrode and a ribbon-shaped negative electrode as well as at least one ribbon-shaped separator are fed separately to a winding machine and spirally wound into a coil with the sequence positive electrode/separator/negative electrode. In a winding formed in this way, the electrodes are connected via the separator. In the vast majority of cases, however, it is not advisable to glue the electrodes to the separator or connect them in a similar way. In the second case, a ribbon-shaped positive electrode and a ribbon-shaped negative electrode and at least one ribbon-shaped separator are first combined to form an electrode-separator assembly, for example by applying the aforementioned pressure. In a further step, the assembly is then wound up.

For applications in the automotive sector, for e-bikes or for other applications with high energy requirements, such as in tools, lithium-ion cells with the highest possible energy density are required that are also capable of withstanding high currents during charging and discharging.

Cells for the aforementioned applications are often designed as cylindrical round cells, for example with a form factor of 21×70 (diameter*height in mm) Cells of this type always comprise an assembly in the form of a winding. Modern lithium-ion cells of this form factor can already achieve an energy density of up to 270 Wh/kg. However, this energy density is only considered an intermediate step. The market is already demanding cells with even higher energy densities.

The housing of cylindrical round cells generally comprises a housing cup, which serves as a receptable for the wound electrode-separator assembly, and a lid component, which closes the opening of the housing cup. A seal is arranged between the lid component and the housing cup, which on the one hand serves to seal the cell housing, but on the other hand also has the function of electrically insulating the lid component and the housing cup from each other. The seal is usually mounted on the edge of the lid component. To seal the round cells, the opening edge of the housing cup is generally bent radially inwards over the edge of the lid component enclosed by the seal (crimping process), so that the lid component including the seal is positively fixed in the opening of the housing cup.

WO 2017/215900 A1 describes cylindrical round cells in which the electrode-separator assembly and its electrodes are ribbon-shaped and in the form of a winding. The electrodes each have ribbon-shaped electrodes loaded with electrode material. Oppositely polarized electrodes are arranged offset to each other within the electrode-separator assembly so that longitudinal edges of the current collectors of the positive electrodes protrude from the winding on one side and longitudinal edges of the current collectors of the negative electrodes protrude from the winding on another side. For electrical contacting of the current collectors, the cells have sheet metal parts that rest flat on the end faces of the winding and are connected by welding to the longitudinal edges of the current collectors. This makes it possible to electrically contact the current collectors and thus also the associated electrodes over their entire length. Cells with windings contacted in this way have a significantly reduced internal resistance. As a result, the occurrence of large currents can be absorbed much better and heat can also be dissipated better from the winding.

In the case of contact plate design/end face winding contacting, very solid metallic contacting elements are preferred in order to provide high cross-sections for high electrical and thermal conductivities. However, cells with such solid internal contact elements are susceptible to short circuits, which can result in particular from deformation of the housing as a result of an external mechanical force. For cells used in the automotive area, for example, the risk of such damage is very real. In addition, height calibration may also be required during cell production, in which the cells are specifically compressed. The axial forces applied here can also cause short circuits within the cells.

### SUMMARY

In an embodiment, the present disclosure provides an energy storage cell. The energy storage cell includes an electrode-separator assembly with the sequence anode/separator/cathode. The anode is ribbon-shaped and includes a ribbon-shaped anode current collector with a first longitudinal edge, a second longitudinal edge parallel thereto, a main region loaded with a layer of negative electrode material, and a free edge strip extending along the first longitudinal edge. The cathode is ribbon-shaped and includes a ribbon-shaped cathode current collector with a first longitudinal edge, a second longitudinal edge parallel thereto, a main region loaded with a layer of positive electrode material, and a free edge strip extending along the first longitudinal edge and being not loaded with the positive electrode material. The electrode-separator assembly is in the form of a cylindrical winding with a first terminal end face bounded by a circumferential edge and a second terminal end face bounded by a circumferential edge and a winding shell located therebetween. The anode and the cathode are arranged within the electrode-separator assembly such that the first longitudinal edge of the anode current collector protrudes from one of the terminal end faces and the first longitudinal edge of the cathode current collector protrudes from the other terminal end face of the electrode-separator assembly. The cell further includes an airtight and liquid-tight housing cup comprising a bottom and a terminal circular opening. The cell also includes a lid component with a circular edge that closes the terminal circular opening. In the housing cup, the electrode-separator assembly is arranged in axial alignment, with the first end face pointing towards the lid component and the second end face pointing towards the bottom, in certain cases being in direct contact with the bottom. The cell includes an annular seal made of an electrically insulating material that encloses the circular edge of the lid component and electrically insulates the housing cup and the lid component from each other. The cell includes a sheet metal component connected by welding to a respective first longitudinal edge of a current collector protruding from the first terminal end face, wherein this current collector is electrically connected to the lid component via the sheet metal component. The cell includes at least one insulating element made of an electrically insulating material that protects the sheet metal component and/or the first longitudinal edge of the current collector protruding from the first end face and/or the separate electrical conductor fixed to the sheet metal component from direct contact with the inner side of the housing cup, in particular in the region of the indentation. The housing cup comprises an inner side and an outer side and, in axial sequence, a bottom, a central section and a closure section, wherein the central section is cylindrical and in the central section the winding shell of the electrode-separator assembly in the form of a winding is in contact with the inner side of the housing cup, and in the closure section, the annular seal is in press contact with the lid component and the inner side of the housing cup. The central section and the closure section are separated by an indentation which annularly circumferentially surrounds the outer side of the housing cup.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a first embodiment of an energy storage cell (cross-sectional view);

FIG. 2 illustrates a second embodiment of an energy storage cell;

FIG. 3 illustrates a third embodiment of an energy storage cell (cross-sectional view);

FIG. 4AD illustrate several embodiments of a sheet metal component which is suitable for contacting the first longitudinal edge of the current collector protruding from the first terminal end face of an energy storage cell (perspective view);

FIG. 5 illustrates an electrode-separator assembly, which is part of an energy storage cell, and its components (top view or perspective view);

FIG. 6 illustrates further embodiments of the sheet metal component which is suitable for contacting the first longitudinal edge of the current collector protruding from the first terminal end face of an energy storage cell (perspective view);

FIG. 7 provides photos of a longitudinal section through an energy storage cell (sectional view); and

FIG. 8 provides drawings of a longitudinal section through a further energy storage cell (also sectional view).

### DETAILED DESCRIPTION

The present disclosure provides energy storage cells that are characterized by a high energy density. Furthermore, the energy storage cells should also be characterized in particular by improved safety.

According to a first aspect, an energy storage cell has the features a. to n. immediately below:
a. The cell comprises an electrode-separator assembly with the sequence anode/separator/cathode.
b. The anode of the electrode-separator assembly is ribbon-shaped and comprises a ribbon-shaped anode current collector which has a first longitudinal edge and a second longitudinal edge parallel thereto.
c. The ribbon-shaped anode current collector comprises a main region loaded with a layer of negative electrode material and a free edge strip extending along its first longitudinal edge which is not loaded with the negative electrode material.
d. The cathode of the electrode-separator assembly is ribbon-shaped and comprises a ribbon-shaped cathode current collector which has a first longitudinal edge and a second longitudinal edge parallel thereto.
e. The ribbon-shaped cathode current collector comprises a main region loaded with a layer of positive electrode material and a free edge strip extending along its first longitudinal edge which is not loaded with the electrode material.
f. The electrode-separator assembly is in the form of a cylindrical winding with a first terminal end face bounded by a circumferential edge and a second terminal end face bounded by a circumferential edge and a winding shell between them and comprises the anode and the cathode in spirally wound form.
g. The anode and the cathode are arranged within the electrode-separator assembly in such a way that the first longitudinal edge of the anode current collector protrudes from one of the terminal end faces and the first longitudinal edge of the cathode current collector protrudes from the other terminal end face of the electrode-separator assembly.
h. The cell comprises an airtight and liquid-tight housing which has a metallic housing cup with a bottom and a terminal circular opening and a lid component with a circular edge which closes the terminal circular opening.
i. In the housing cup, the electrode-separator assembly is arranged in axial alignment, with the first end face pointing towards the lid component and the second end face pointing towards the bottom, in certain cases being in direct contact with the bottom.
j. The cell comprises an annular seal made of an electrically insulating material which encloses the circular edge of the lid component and electrically insulates the housing cup and the lid component from each other.
k. The housing cup comprises an inner side and an outer side and, in axial sequence, the bottom, a central section and a closure section, wherein the central section is cylindrical and in the central section the winding shell of the electrode-separator assembly in the form of a winding is in contact with the inner side of the housing cup, and in the closure section, the annular seal is in press contact with the lid component and the inner side of the housing cup.
l. The central section and the closure section are separated by an indentation that circumferentially surrounds the outer side of the housing cup.
m. The cell comprises a sheet metal component, optionally including a separate electrical conductor fixed to the sheet metal component, wherein the sheet metal component is connected by welding to the first longitudinal edge of the current collector protruding from the first terminal end face and wherein this current collector is electrically connected to the lid component via sheet metal component.

The cell is particularly characterized by the following feature:
n. The cell comprises at least one insulating element made of an electrically insulating material, which protects the sheet metal component and/or the first longitudinal edge of the current collector protruding from the first terminal end face and/or the separate electrical conductor fixed to the sheet metal component from direct contact with the inner side of the housing cup, in particular in the region of the indentation.

This measure ensures that the risk of a short circuit in the cell-internal contact area is reduced. Axial forces occurring in connection with height calibration, for example, generally no longer result in direct contact between oppositely polarized cell components. These are prevented by the at least one insulating element.

The bottom of the housing cup is preferably circular. The housing cup is usually formed by deep drawing. However, it is also possible, for example, to form the cup by welding a bottom into a tubular half-part.

Preferably, the housing cup has a wall thickness in a range from 0.1 mm to 2 mm.

The housing cup preferably consists of aluminum, an aluminum alloy or a sheet steel, for example a nickel-plated sheet steel. Preferably, stainless steel can also be used.

Suitable aluminum alloys for the housing cup are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5 %.

The energy storage cell is preferably a cylindrical round cell. Preferably, the height of a cylindrical round cell of the energy storage cell is in a range from 50 mm to 150 mm. Its diameter is preferably in a range from 15 mm to 60 mm. Cylindrical round cells with these form factors are suitable, for example, for supplying power to electric drives in motor vehicles.

The electrode-separator assembly is preferably manufactured using two ribbon-shaped separators. Preferably, the assembly has the sequence separator/anode/separator/cathode or anode/separator/cathode/separator. The separator or separators then enclose either the anode or the cathode. Their task is to avoid direct electrical contact between oppositely polarized electrodes within the winding and at the same time to allow an exchange of ions between the electrodes.

### Lithium-Ion Cell Version

In a preferred embodiment, the energy storage cell is a lithium-ion cell.

Basically, all electrode materials known for secondary lithium-ion cells can be used for the electrodes of the energy storage cell.

Carbon-based particles such as graphitic carbon or non-graphitic carbon materials capable of intercalating lithium, preferably also in particle form, can be used as active materials in the negative electrodes. Alternatively or additionally, lithium titanate (Li₄Ti₅O₁₂) or a derivative thereof can also be contained in the negative electrode, preferably also in particle form. Furthermore, the negative electrode can contain as active material at least one material from the group comprising silicon, aluminum, tin, antimony or a compound or alloy of these materials that can reversibly store and release lithium, for example silicon oxide (in particular SiOₓ with 0<x<2), optionally in combination with carbon-based active materials. Tin, aluminum, antimony and silicon can form intermetallic phases with lithium. The capacity for the receptability of lithium exceeds that of graphite or comparable materials many times over, especially in the case of silicon. Mixtures of silicon and carbon-based storage materials are often used. Silicon-carbon composites (SiC), for example, are also particularly suitable. Thin anodes made of metallic lithium are also suitable.

Suitable active materials for the positive electrodes include lithium metal oxide compounds and lithium metal phosphate compounds such as LiCoO₂ and LiFePO₄. Lithium nickel manganese cobalt oxide (NMC) with the chemical formula LiNiₓMn_{y}Co_{z}O₂ (where x+y+z is typically 1) is also particularly suitable, lithium manganese spinel (LMO) with the chemical formula LiMn₂O₄, or lithium nickel cobalt aluminum oxide (NCA) with the chemical formula LiNiₓCo_{y}Al_{z}O₂ (where x+y+z is typically 1). Derivatives thereof, for example lithium nickel manganese cobalt aluminum oxide (NMCA) with the chemical formula Li_{1.11}(Ni_{0.40}Mn_{0.39}Co_{0.16}Al_{0.05})_{0.89}O₂ or Li₁₊ₓM—O compounds and/or mixtures of the aforementioned materials can also be used. The cathodic active materials are also preferably used in particulate form.

In addition, the electrodes of an energy storage cell preferably contain an electrode binder and/or an additive to improve the electrical conductivity. The active materials are preferably embedded in a matrix of the electrode binder, with neighboring particles in the matrix preferably being in direct contact with each other. Conductive agents have the function of elevating the electrical conductivity of the electrodes. Common electrode binders are based, for example, on polyvinylidene fluoride (PVDF), (Li-)polyacrylate, styrene-butadiene rubber or carboxymethyl cellulose or mixtures of different binders. Common conductive agents are carbon black, fine graphite, carbon fibers, carbon nanotubes and metal powder.

The energy storage cell preferably comprises an electrolyte, in the case of a lithium-ion cell in particular an electrolyte based on at least one lithium salt such as lithium hexafluorophosphate (LiPF₆), which is present dissolved in an organic solvent (e.g. in a mixture of organic carbonates or a cyclic ether such as THF or a nitrile). Other lithium salts that can be used are, for example, lithium tetrafluoroborate (LiBF₄), lithium bis(trifluoromethanesulfonyl)imide (LiTFSI), lithium bis(fluorosulfonyl)imide (LiFSI) and lithium bis(oxalato)borate (LiBOB).

The nominal capacity of a lithium-ion-based energy storage cell designed as a cylindrical round cell is preferably up to 15000 mAh. With the form factor of 21×70, the energy storage cell in an embodiment as a lithium-ion cell preferably has a nominal capacity in a range from 1500 mAh to 7000 mAh, preferably in a range from 3000 to 5500 mAh. With the form factor of 18×65, the cell in an embodiment as a lithium-ion cell preferably has a nominal capacity in a range from 1000 mAh to 5000 mAh, preferably in a range from 2000 to 4000 mAh.

In the European Union, manufacturer information on the nominal capacity of secondary batteries is strictly regulated. For example, information on the nominal capacity of secondary nickel-cadmium batteries must be based on measurements in accordance with the IEC/EN 61951-1 and IEC/EN 60622 standards, information on the nominal capacity of secondary nickel-metal hydride batteries must be based on measurements in accordance with the IEC/EN 61951-2 standard, information on the nominal capacity of secondary lithium batteries must be based on measurements in accordance with the IEC/EN 61960 standard and information on the nominal capacity of secondary lead-acid batteries must be based on measurements in accordance with the IEC/EN 61056-1 standard. Any information on nominal capacities in the present application is preferably also based on these standards.

### Sodium-Ion Cell Embodiment

Alternatively, the energy storage cell may also be a sodium-ion cell, a potassium-ion cell, a calcium-ion cell, a magnesium-ion cell or an aluminum-ion cell. In further possible embodiments, the energy storage cell comprises a sodium-ion cell, a potassium-ion cell, a calcium-ion cell, a magnesium-ion cell or an aluminum-ion cell. Among these variants, energy storage cells with sodium ion cell chemistry are preferred.

The negative electrode material of an energy storage element based on sodium ions is, for example, one of the following materials:
carbon, especially hard carbon (pure or with nitrogen and/or phosphorus doping) or soft carbon or graphene-based materials, carbon nanotubes, graphite
phosphorus or sulphur
polyanions such as Na₂Ti₃O₇, Na₃Ti₂(PO₄)₃, TiP₂O₇, TiNb₂O₇, Na—Ti—(PO₄)₃, Na—V—(PO₄)₃
Transition metal oxides such as V₂O₅, MnO₂, TiO₂, Nb₂O₅, Fe₂O₃, Na₂Ti₃O₇, NaCrTiO₄, Na₄Ti₅O₁₂

Alternatively, a Na metal anode can also be used on the anode side.

The positive electrode material of an energy storage element based on sodium ions is, for example, one of the following materials:
polyanions: NaFePO₄ (triphylite type), Na₂Fe(P₂O₇), Na₄Fe₃(PO₄)₂(P₂O₇), Na₂FePO₄F, Na/Na₂[Fe_{1/2}Mn_{1/2}]PO₄F, Na₃V₂(PO₄)₂F₃, Na₃V₂(PO₄)₃, NaCoPO₄, Na₂CoPO₄F
silicates: Na₂MnSiO₄, Na₂FeSiO₄
Layered oxides: NaCoO₂, NaFeO₂, NaNiO₂, NaCrO₂, NaVO₂, NaTiO₂, Na(FeCo)O₂, Na(NiFeCo)₃O₂, Na(NiFeMn)O₂, and Na(NiFeCoMn)O₂, Na(NiMnCo)O₂

As with lithium-ion cells, electrodes based on sodium ions can also comprise an electrode binder and/or an additive to improve electrical conductivity. Suitable electrode binders are based, for example, on polyvinylidene fluoride (PVDF), (Li-)polyacrylate, styrene-butadiene rubber or carboxymethyl cellulose or mixtures of different binders. Suitable conductive agents are carbon black, fine graphite, carbon fibers, carbon nanotubes and metal powder.

An energy storage cell based on sodium ions preferably comprises an electrolyte comprising at least one of the following solvents and at least one of the following conducting salts:

Organic carbonates, ethers, nitriles and mixtures thereof are particularly suitable as solvents.

Preferred lead salts are NaPF₆, sodium difluoro(oxalato)borate (NaBOB), NaBF₄, sodium bis(fluorosulfonyl)imide (NaFSI), sodium 2-trifluoromethyl-4,5-dicyanoimidazole (NaTDI), sodium bis(trifluoromethanesulfonyl)imide (NaTFSI), NaAsF₆, NaBF₄, NaClO₄, NaB(C₂O₄)₂, NaP(C₆H₄O₂)₃; NaCF₃SO₃, sodium triflate (NaTf) and Et₄NBF₄.

In preferred embodiments, additives may be added to the electrolyte.

The nominal capacity of a sodium-ion-based energy storage cell designed as a cylindrical round cell is preferably up to 12000 mAh. With the form factor of 21×70, the energy storage cell in an embodiment as a lithium-ion cell preferably has a nominal capacity in a range from 1200 mAh to 5500 mAh, preferably in a range from 2500 to 4500 mAh. With the form factor of 18×65, the cell in an embodiment as a lithium-ion cell preferably has a nominal capacity in a range from 800 mAh to 4500 mAh, preferably in a range from 1600 to 3200 mAh.

### Protection of the End Face Edges of the Electrode-Separator Assembly

In a first preferred embodiment, the energy storage cell is characterized by at least one of the features a. to c. immediately below:
a. The at least one insulating element is or comprises an insulating tape which is applied to the edge delimiting the end face and protects it from direct contact with the inner side.
b. The at least one insulating element is or comprises an annular molded part made of plastic, preferably with an L-shaped cross-section, which is applied to the edge delimiting the end face and protects it from direct contact with the inner side.
c. The insulating tape or the annular molded plastic part has a thickness in a range from 10 μm to 200 μm.

It is preferred that the immediately preceding features a. and c. as well as b. and c. are realized in combination.

The insulating tape can be a Kapton/polyimide adhesive tape, for example.

The annular molded plastic part, preferably with an L-shaped cross-section, can be injection molded, for example, and pushed onto the edge to be protected. It can consist of Teflon or polyamide, for example.

### Protection of the Inner Side of the Housing Cup

In a second preferred embodiment, the energy storage cell is characterized by at least one of the features a. to c. immediately below:
a. The at least one insulating element is or comprises an annular insulating element made of plastic, which rests against the inner side of the housing cup in the region of the indentation and protects it from direct contact with the sheet metal component.
b. The annular insulating element is a partial section of the annular seal.
c. The annular insulating element made of plastic has a thickness in a range from 20 μm to 400 μm.

It is preferred that the immediately preceding features a. and b. are realized in combination. Features a. to c. are preferably realized in combination.

The annular insulating element can also be an injection-molded part, as can the annular seal. The thickness of the insulating element is preferably in a range from 20 μm to 400 μm.

The annular insulating element can consist of Teflon, polyamide, polybutylene terephthalate or a perfluoroalkoxy polymer, for example.

### Protection of the Sheet Metal Component Welded to the Current Collector Protruding From the First End Face

In a third preferred embodiment, the energy storage cell is characterized by at least one of the features a. to d. immediately below:
a. The at least one insulating element is or comprises an annular plastic part which encloses the sheet metal component and protects it from direct contact with the inner side of the housing cup in the region of the indentation.
b. The annular plastic part is hollow-cylindrical, comprises a shell and is bounded at the end face by a circumferential edge.
c. The annular plastic part is hollow-cylindrical in shape, comprises a shell and is each bounded at the end face by a circumferential edge, one of the edges being designed as an outwardly directed annular collar and resting on the sheet metal component.
d. The annular plastic part has a thickness in a range from 20 μm to 600 μm.

It is preferred that the immediately preceding features a. and b., preferably features a. and b. and d., are realized in combination. It is preferred that the immediately preceding features a. and c. and d. are realized in combination.

The annular plastic part can also be an injection molded part. The thickness of the plastic part is preferably in a range from 20 μm to 600 μm.

The plastic part can, for example, be made of Teflon, polyamide, polybutylene terephthalate or a perfluoroalkoxy polymer.

### Protection of the Edge of the Sheet Metal Component

In a fourth preferred embodiment, the energy storage cell is characterized by at least one of the features a. to d. immediately below:
a. The at least one insulating element is or comprises an electrically insulating plastic coating which encloses an edge of the sheet metal component and protects it from direct contact with the inner side of the housing cup, in particular in the region of the indentation.
b. The electrically insulating coating is formed by overmolding the edge of the sheet metal component.

It is preferred that the immediately preceding features a. and b. are realized in combination.

Basically, all thermoplastics with electrically insulating properties are suitable for overmolding the edge of the sheet metal component. Polyamide, for example, is suitable.

### Protection Combinations

Combinations of the four embodiments described are also preferred. Thus, the cell is preferably characterized by a combination of two or more of the four features a. to d. immediately below:
a. The at least one insulating element comprises an insulating tape or annular molded part made of plastic, which is applied to the edge delimiting the end face and protects it from direct contact with the inner side, i.e. an insulating tape or an annular molded part according to the first preferred embodiment, and/or
b. the at least one insulating element comprises an annular insulating element which rests against the inner side of the housing cup in the region of the indentation and protects it from direct contact with the sheet metal component, i.e. an annular insulating element according to the second preferred embodiment, and/or
c. the at least one insulating element comprises an annular plastic part which encloses the sheet metal component and protects it from direct contact with the inner side of the housing cup in the region of the indentation, i.e. an annular plastic part according to the third preferred embodiment, and/or
d. the at least one insulating element is or comprises an electrically insulating plastic coating which encloses an edge of the sheet metal component and protects it from direct contact with the inner side of the housing cup, in particular in the region of the indentation, i.e. a plastic coating according to the fourth preferred embodiment.

### Preferred Embodiment of the Indentation

It is preferred that the cell is characterized by at least one of the following features a. to c:
a. The housing cup has an identical maximum outer diameter in the central section and the closure section.
b. In the region of the indentation, the outer diameter of the housing cup is reduced by 4 to 20 times the wall thickness of the housing cup in this region.

It is preferred that the immediately preceding features a. and b. are realized in combination.

### Electrical Connection of the Sheet Metal Component to the Lid Component

There are two preferred variants for electrically connecting the sheet metal component, which is connected by welding to the first longitudinal edge of the current collector protruding from the first terminal end face, to the lid component.

According to a variant A, the cell is characterized by at least one of the features a. to c. immediately below:
a. The sheet metal component is directly connected to the lid component.
b. The sheet metal component comprises a first section which rests flat on the first longitudinal edge of the current collector protruding from the first terminal end face and extends parallel to the end face.
c. The sheet metal component comprises a second section which is connected to the first section at an angle and via which the first section is electrically connected to the lid component.

It is preferred that the immediately preceding features a. and b. are realized in combination. It is preferred that the immediately preceding features a. to c. are realized in combination.

According to a variant B, the cell is characterized by at least one of the features a. and b. immediately below:
a. The sheet metal component is connected to the lid component via the separate electrical conductor.
b. The sheet metal component rests flat on the first longitudinal edge of the current collector protruding from the first terminal end face.

It is preferred that the immediately preceding features a. and b. are realized in combination.

If the separate electrical conductor is used, it preferably consists of the same material as the sheet metal component itself.

### Electrical Contacting of the First Longitudinal Edge of the Current Collector Protruding From the Second Terminal End Face

Of course, not only the first longitudinal edge of the current collector protruding from the first terminal end face must be electrically contacted. Rather, the first longitudinal edge of the current collector protruding from the second terminal end face must also be electrically contacted. The following two variants are preferred:

According to a variant C, the cell is characterized by the feature a. immediately below:
a. The first longitudinal edge of the current collector protruding from the second terminal end face rests directly on the bottom of the housing cup and is connected to it by welding.

According to a variant D, the cell is characterized by feature b. immediately below:
b. The cell comprises a sheet metal component which is connected by welding to the first longitudinal edge of the current collector protruding from the second terminal end face and via which this current collector is electrically connected to the bottom of the housing cup.

In both cases, the longitudinal edge of the current collector protruding from the second terminal end face can ideally be electrically and/or thermally connected over its entire length, as in the case of the current collector protruding from the first terminal end face.

The cell is preferably characterized by the following feature a:
a. The current collector protruding from the first terminal end face is the anode current collector and the current collector protruding from the second end face is the cathode current collector.

This configuration is particularly advantageous if the housing consists of aluminum or an aluminum-containing alloy, as described above. Since the cathode current collector also preferably consists of aluminum, see below.

### Preferred Embodiments of the Sheet Metal Component

In a preferred further development of the invention, the sheet metal component electrically connected to the anode current collector is characterized by at least one of the features a. or b. immediately below:
a. The sheet metal component consists of nickel or copper or titanium or a nickel or copper or titanium alloy or stainless steel, for example of type 1.4303 or 1.4404 or of type SUS304, or of nickel-plated copper.
b. The sheet metal component consists of the same material as the anode current collector.

It is preferred that the immediately preceding features a. and b. are realized in combination.

In embodiments in which the cathode current collector is also electrically connected via a sheet metal component, this sheet metal component is characterized by at least one of the features a. and b. immediately below:
a. The sheet metal component consists of aluminum or an aluminum alloy.
b. The sheet metal component consists of the same material as the cathode current collector.

It is preferred that the immediately preceding features a. and b. are realized in combination.

Sheet metal components that can be used for contacting the longitudinal edges of the current collectors are preferably characterized by at least one of the immediately following features a. to g:
a. They have a preferably uniform thickness in a range from 50 μm to 600 μm, preferably in a range from 150 μm to 350 μm.
b. They have two opposing flat sides and essentially only extend in one dimension.
c. They are in the form of a disk or polygonal plate or comprise such a disk or plate.
d. They are dimensioned in such a way that they cover at least 50 %, preferably at least 60 %, preferably at least 70 % of the first terminal and/or the second terminal end face.
e. They have at least one aperture, in particular at least one hole and or at least one slot.
f. They have at least one bead, which appears on one flat side of the sheet metal component as an elongated depression and on the opposite flat side as an elongated elevation, with the flat side bearing the elongated elevation resting on the first longitudinal edge of the respective current collector.
g. They are welded to the first longitudinal edge of the respective current collector in the region of the bead, in particular via one or more weld seams arranged in the bead.

It is preferred that the immediately preceding features a. and b. and d. are realized in combination with each other. In a preferred embodiment, features a. and b. and d. are realized in combination with one of features c. or e. or features f. and g. preferably, all features a. to g. are realized in combination with each other.

Covering as much of the end face as possible is important for the thermal management of the energy storage cell. The larger the cover, the easier it is to contact the first longitudinal edge of the respective current collector over its entire length, if possible. Heat formed in the electrode-separator assembly can thus be dissipated well via the sheet metal component(s).

In some embodiments, it has proven advantageous to subject the longitudinal edge of a current collector to a pre-treatment before a sheet metal component is placed on top. In particular, at least one depression can be folded into the longitudinal edge, which corresponds to the at least one bead or the elongated elevation on the corresponding flat side of the sheet metal component.

The longitudinal edges of the current collectors may also have been subjected to directional forming by pre-treatment. For example, they can be bent in a defined direction.

The at least one aperture in the sheet metal components can be useful, for example, in order to be able to impregnate the electrode-separator assembly with an electrolyte.

### Preferred Embodiments of the Current Collectors

The anode current collector, the cathode current collector and the separator or separators of the cell preferably have the following dimensions:
A length in a range from 0.5 m to 25 m
A width in a range from 40 mm to 145 mm

It is preferred that, in order to produce the ribbon-shaped electrode-separator assembly, the ribbon-shaped electrodes together with the ribbon-shaped separator(s) are fed to a winding device and are preferably wound up spirally around a winding axis in the winding device. In some embodiments, the electrodes and the separator or separators are wound onto a cylindrical or hollow-cylindrical winding core for this purpose, which is seated on a winding mandrel and remains in the winding after winding.

The winding shell can be formed by a plastic film or an adhesive tape, for example. It is also possible for the winding shell to be formed by one or more separator windings.

The current collectors of the energy storage cell have the function of electrically contacting electrochemically active components contained in the respective electrode material over as large an area as possible. Preferably, the current collectors consist of a metal or are at least metallized on the surface.

In the case of a lithium-ion cell, suitable metals for the anode current collector are, for example, copper or nickel or other electrically conductive materials, in particular copper and nickel alloys or metals coated with nickel. In particular, materials of type EN CW-004A or EN CW-008A with a copper content of at least 99.9% can be used as copper alloys. Alloys of the type NiFe, NiCu, CuNi, NiCr and NiCrFe are particularly suitable as nickel alloys. Alloys of the type NiFe, NiCu, CuNi, NiCr and NiCrFe are particularly suitable as nickel alloys. Stainless steel can also be considered, for example type 1.4303 or 1.4404 or type SUS 304.

In the case of a lithium-ion cell designed as an energy storage cell, aluminum or other electrically conductive materials, including aluminum alloys, are particularly suitable as the metal for the cathode current collector.

In the case of an energy storage cell designed as a sodium-ion cell, the anode current collector and the cathode current collector can both consist of aluminum or an aluminum alloy.

Suitable aluminum alloys for the cathode current collector are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5 %.

Preferably, the ribbon-shaped anode current collector and/or the cathode current collector are each a ribbon-shaped metal foil with a thickness in a range from 4 μm to 30 μm. In this case, the current collectors are also referred to as current collector foils

However, in addition to films, other strip-shaped substrates such as metallic or metallized nonwovens or open-pored metallic foams or expanded metals can also be used as current collectors.

The current collectors are preferably loaded with the respective electrode material on both sides.

In some embodiments, it is preferred-primarily for reasons of thermal bonding-that the outer winding layer consists of uncoated metal foils which are in direct contact with the housing. For example, in the case of an aluminum housing, a terminal section of an aluminum current collector foil of the cathode that is not coated with electrode material can form the outer turn of the winding and at the same time rest directly against the aluminum housing. In the case of a nickel-plated steel housing, for example, a terminal section of a current collector foil of the anode consisting of copper or nickel that is not coated with electrode material can form the outer turn of the winding and rests against the housing.

In these cases, the winding shell is formed by the terminal section of the respective current collector foil.

It is preferred that the longitudinal edges of the separator or separators form the end faces of the electrode-separator assembly, which is formed as a winding.

### Method

The method is used to manufacture an energy storage cell and is characterized by the following features and steps:
a. An energy storage cell as described above is provided, in particular an energy storage cell having the features a. to n. of claim 1 is provided.
b. The energy storage cell is subjected to a height calibration, by which the closure section and the central section are pushed against each other under plastic deformation of the indentation, so that the distance between the sheet metal component, which is connected by welding to the first longitudinal edge of the current collector protruding from the first terminal end face, and the lid component becomes smaller.

In the production of an energy storage cell of the type described above, it is almost unavoidable that a dead volume is formed between the sheet metal component, which is connected by welding to the first longitudinal edge of the current collector protruding from the first terminal end face, and the lid component, which reduces the energy density of the energy storage cell. According to the present disclosure, this is countered by the aforementioned height calibration, in which the closure section and the central section are pushed against each other, preferably by axial forces. In conventional cells, this step is a very critical one, since as a result of the axial forces, deformations of the wall of the housing cup, of the sheet metal component protruding from the first end face by welding to the first longitudinal edge of the current collector and of the separate electrical conductor connecting the sheet metal component to the lid component can occur. As a result of these deformations, short circuits can occur within the energy storage cell.

The design of the described energy storage cell with the at least one insulating element allows height calibration to be carried out with a significantly reduced risk of short circuits. For example, it is possible to initially assemble a type 21700 cell with a height>700 mm and to reduce the resulting dead volume in a subsequent step as part of the aforementioned height calibration. In this way, cells with increased energy density can be produced.

Preferably, the distance between the sheet metal component (112) and the lid component (102), relative to the distance before height calibration, is reduced by at least 10 %, particularly preferably by at least 20 %, further preferably by at least 30 %. In absolute figures, the reduction in distance, depending on the dimensions of the cell, can be in a range from 0.5 mm to 5 mm, for example.

In contrast to so-called elastic deformation, the skilled person understands the aforementioned plastic deformation to be a permanent deformation that is structurally reflected in the height-calibrated product. This applies in particular to the indentation located between the central section and the closure section.

In preferred embodiments, an energy storage cell that has undergone the described altitude calibration is characterized by the immediately following features a:
a. The indentation comprises an annular opening slot and an annular cavity with an undercut accessible via the opening slot.

According to the invention, such an undercut is formed by the height calibration, since the closure section and the central section can be pushed further towards each other than is the case with conventional cells. Preferably, the indentation has a lower height in the axial direction in the region of the opening slit than in the region of the undercut.

Even better results can be achieved if the indentation is formed asymmetrically before the height calibration. In preferred embodiments, an energy storage cell, before being subjected to the described height calibration, is characterized by the features a. to e. immediately below:
a. The housing of the energy storage cell is essentially cylindrical in shape and the energy storage cell has a central axis which is guided vertically through the bottom of the housing cup.
b. The housing cup has an identical maximum outer diameter in the central section and the closure section, while the outer diameter is reduced in the region of the indentation.
c. A housing cup segment in which the outer diameter in the region of the indentation is reduced extends over a height S1.
d. A plane E1, which is placed through the deepest point of the indentation and intersects the central axis perpendicularly, divides the housing cup segment into an upper part segment facing the lid component with a height S2 and a lower part segment facing the electrode-separator assembly with a height S3.
e. S3>S2

Particularly preferably, S3 is at least 20 %, more preferably at least 30 %, in particular at least 40 %, longer than S2.

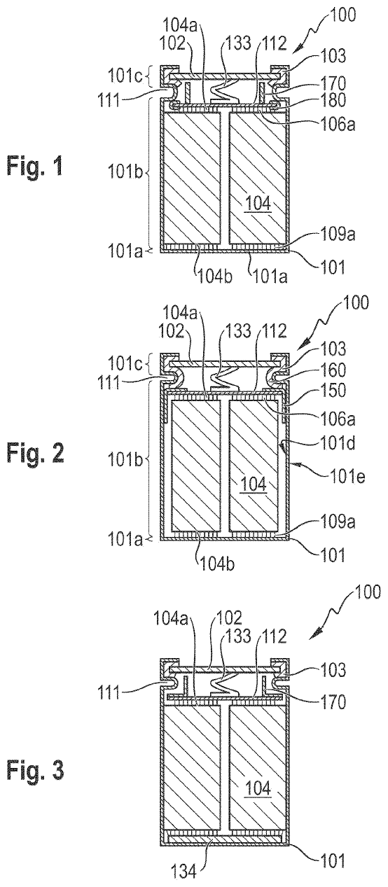

FIG. 1 shows an energy storage cell 100 with an airtight and liquid-tight housing which comprises a metallic housing cup 101 with a terminal circular opening and a lid component 102 with a circular edge 102a which closes the circular opening. The cell further comprises a ring-shaped seal 103 made of an electrically insulating material, which encloses the circular edge 102a of the lid component 102 and electrically insulates the housing cup 101 and the lid component 102 from each other. The housing cup 101 comprises in axial sequence a bottom 101a, a central section 101b and a closure section 101c, wherein the central section 101b is cylindrical and in the central section 101b the winding shell 104c of the electrode-separator assembly 104, which is formed as a winding, is in contact with the inner side 101d of the housing cup 101, and in the closure section 101c the annular seal 103 is in press contact with the lid component 102 and the inner side of the housing cup 101. The central section 101b and the closure section 101c are separated by an indentation 111, which annularly circumferentially surrounds the outer side 101e of the housing cup 101.

The cell 100 also comprises an electrode-separator assembly 104 in the form of a cylindrical winding with the sequence anode/separator/cathode, although this is not shown in detail here. Only the longitudinal edge 106a of the anode current collector 106, which protrudes from the end face 104a of the electrode-separator assembly 104, and the longitudinal edge 109a of the cathode current collector 109, which protrudes from the end face 104b of the electrode-separator assembly 104, can be seen. The longitudinal edge 109a is welded, preferably over its entire length, directly to the housing bottom 101a. The longitudinal edge 106a is welded, preferably over its entire length, directly to the sheet metal component 112. The sheet metal component 112 is in turn connected to the lid component 102 via the electrical conductor 133.

The cell 100 preferably has a height in a range from 60 mm to 100 mm, and its diameter is preferably in a range from 20 mm to 50 mm. The housing cup 101 typically has a wall thickness in a range from 0.1 mm to 0.3 mm in the central section 101b.

As an insulating element, the cell comprises an electrically insulating plastic coating 180 which encloses an edge of the sheet metal component 112 and protects it from direct contact with the inner side 101d of the housing cup 101, in particular in the region of the indentation 111. The electrically insulating coating 180 is formed by overmolding the edge of the sheet metal component 112. Furthermore, the cell 100 comprises an annular plastic part 170 as an insulating element, which encloses the separate electrical conductor 133 fixed to the sheet metal part and protects it from direct contact with the inner side 101d of the housing cup 101 in the region of the indentation 111.

As a result, the cell 100 is excellently protected against short circuits even if the housing is deformed by an external mechanical force.

FIG. 2 shows an energy storage cell 100 with an airtight and liquid-tight housing comprising a metallic housing cup 101 with a terminal circular opening and a lid component 102 with a circular edge 102a which closes the circular opening. The cell further comprises a ring-shaped seal 103 made of an electrically insulating material, which encloses the circular edge 102a of the lid component 102 and electrically insulates the housing cup 101 and the lid component 102 from each other. The housing cup 101 comprises, in axial sequence, a bottom 101a, a central section 101b and a closure section 101c, wherein the central section 101b is cylindrical and in the central section 101b the winding shell 104c of the electrode-separator assembly 104, which is formed as a winding, is in contact with the inner side 101d of the housing cup 101 (Attention: For reasons of clarity only, the electrode-separator assembly 104 is shown at a distance from the inner side 101d, but it actually presses against it, as shown, for example, in FIG. 1), and in the closure section 101c the annular seal 103 is in press contact with the lid component 102 and the inner side of the housing cup 101. The central section 101b and the closure section 101c are separated by an indentation 111, which circumferentially surrounds the outer side 101e of the housing cup 101 in an annular manner.

The cell 100 also comprises an electrode-separator assembly 104 in the form of a cylindrical winding with the sequence anode/separator/cathode, although this is not shown in detail here. Only the longitudinal edge 106a of the anode current collector 106, which protrudes from the end face 104a of the electrode-separator assembly 104, and the longitudinal edge 109a of the cathode current collector 109, which protrudes from the end face 104b of the electrode-separator assembly 104, can be seen. The longitudinal edge 109a is welded, preferably over its entire length, directly to the housing bottom 101a. The longitudinal edge 106a is welded, preferably over its entire length, directly to the sheet metal component 112. The sheet metal component 112 is in turn connected to the lid component 102 via the electrical conductor 133.

The cell 100 preferably has a height in a range from 60 mm to 100 mm, and its diameter is preferably in a range from 20 mm to 50 mm. The housing cup 101 typically has a wall thickness in a range from 0.1 mm to 0.3 mm in the central section 101b.

As an insulating element, the cell comprises an annular molded plastic part 150 with an L-shaped cross-section, which is applied to the edge delimiting the end face 104a and protects it from direct contact with the inner side 101d of the housing cup 101. Furthermore, the cell comprises an annular insulating element 160 made of plastic, which rests against the inner side 101d of the housing cup 101 in the region of the indentation 111 and protects it from direct contact with the electrical conductor 133. This may also be a partial section of the annular seal 103, which may be sufficiently high to also cover the indentation 111 from the inner side.

As a result, the cell 100 is excellently protected against short circuits even if the housing is deformed by an external mechanical force.

Instead of the annular molded plastic part 150 with an L-shaped cross-section, the edge delimiting the end face 104a can also be covered with an insulating tape, for example a Kapton tape 150. Ideally, this can already be applied to the edge when the winding is formed and protects the edge just as efficiently from direct contact with the inner side 101d.

FIG. 3 shows an energy storage cell 100 with an airtight and liquid-tight housing which comprises a metallic housing cup 101 with a terminal circular opening and a lid component 102 with a circular edge 102a which closes the circular opening. The cell further comprises a ring-shaped seal 103 made of an electrically insulating material, which encloses the circular edge 102a of the lid component 102 and electrically insulates the housing cup 101 and the lid component 102 from each other. The housing cup 101 comprises in axial sequence a bottom 101a, a central section 101b and a closure section 101c, wherein the central section 101b is cylindrical and in the central section 101b the winding shell 104c of the electrode-separator assembly 104, which is formed as a winding, is in contact with the inner side 101d of the housing cup 101 and in the closure section 101c the annular seal 103 is in press contact with the lid component 102 and the inner side of the housing cup 101. The central section 101b and the closure section 101c are separated by an indentation 111, which annularly circumferentially surrounds the outer side 101e of the housing cup 101.

The cell 100 also comprises an electrode-separator assembly 104 in the form of a cylindrical winding with the sequence anode/separator/cathode, although this is not shown in detail here. Only the longitudinal edge 106a of the anode current collector 106, which protrudes from the end face 104a of the electrode-separator assembly 104, and the longitudinal edge 109a of the cathode current collector 109, which protrudes from the end face 104b of the electrode-separator assembly 104, can be seen. The longitudinal edge 109a is welded, preferably over its entire length, directly to the sheet metal component 134. The sheet metal component 134 is in turn connected to the bottom 101a by welding. The longitudinal edge 106a is welded directly to the sheet metal component 112, preferably over its entire length. The sheet metal component 112 is in turn connected to the lid component 102 via the electrical conductor 133.

The cell 100 preferably has a height in a range from 60 mm to 100 mm, and its diameter is preferably in a range from 20 mm to 50 mm. The housing cup 101 typically has a wall thickness in a range from 0.1 mm to 0.3 mm in the central section 101b.

The cell comprises an annular plastic part 170 as an insulating element, which laterally encloses the electrical conductor 133 and protects it from direct contact with the inner side 101d of the housing cup 101 in the region of the indentation 111. The annular plastic part 170 is hollow-cylindrical in shape and comprises a shell 171 that is perpendicular to the sheet metal component 112. One of its edges is formed as an outwardly directed annular collar 171 and rests on the sheet metal component 112.

As a result, the cell 100 is excellently protected against short circuits even if the housing is deformed by an external mechanical force.

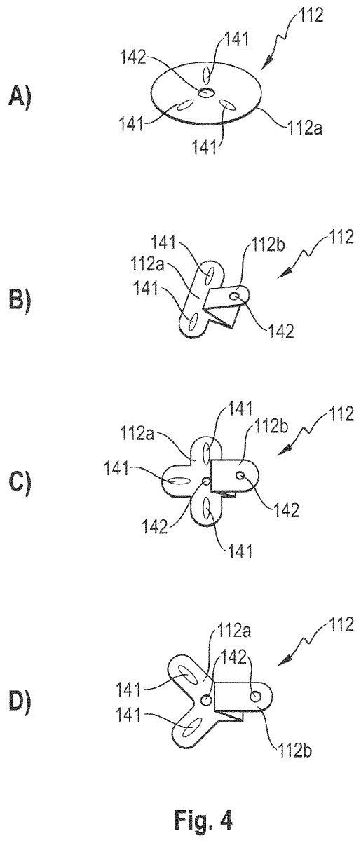

FIG. 4 shows several embodiments of a sheet metal component 112 that is suitable for contacting the first longitudinal edge 106a of the current collector 106 protruding from the first terminal end face 104a of an energy storage cell 100.

Embodiment A shows as sheet metal component 112 a circular and substantially flat metal disc with a circumferential edge 102a. This is characterized by a central hole 142 and three offset beads 141. Such a component can be used in the cells according to FIGS. 1 to 3 in each case for electrical contacting of the edge 106a of the anode current collector 106. However, it is also suitable for use as a sheet metal component 134 in the cell according to FIG. 3. When such a metal disc is used for contacting the longitudinal edge 106a, the separate conductor 133 shown in FIGS. 1 to 3 is generally absolutely necessary in order to bridge the distance to the lid component 102.

Embodiment B is different. Here, the sheet metal component 112 comprises a first section 112a, which can rest flat on the first longitudinal edge of the current collector protruding from the first terminal end face 104a and which then extends parallel to the end face 104a. In addition, however, it additionally comprises a second section 112b which adjoins the first section 112a at an angle and via which the first section 112a is electrically connected to the lid component 102. When using such a sheet metal component, no separate conductor 133 is required. The sheet metal component is further characterized by a hole 142 and two beads 141. In these beads, the sheet metal component is preferably welded to the longitudinal edge of the respective current collector.

Embodiments C and D differ from embodiment B in that the section 112a comprises three and four strips, respectively, which extend in different directions. Each of the strips has a bead 141. In addition, the sheet metal parts each have two holes 142.

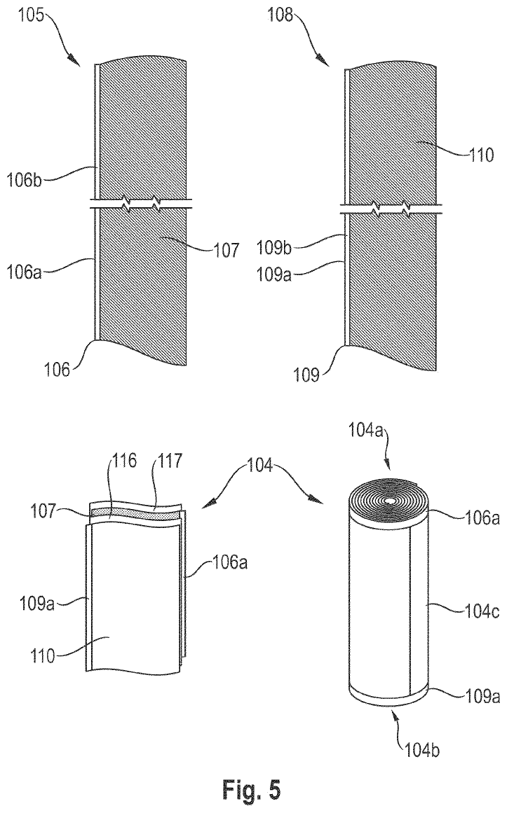

The structure of the electrode-separator assembly 104 is illustrated with reference to FIG. 5. The assembly 104 comprises the ribbon-shaped anode 105 with the ribbon-shaped anode current collector 106, which has a first longitudinal edge 106a and a second longitudinal edge parallel thereto. The anode current collector 106 is a foil made of copper or nickel. This comprises a strip-shaped main region, which is loaded with a layer of negative electrode material 107, and a free edge strip 106b, which extends along its first longitudinal edge 106a and which is not loaded with the electrode material 107. Further, the assembly 104 comprises the ribbon-shaped cathode 108 with the ribbon-shaped cathode current collector 109 having a first longitudinal edge 109a and a second longitudinal edge parallel thereto. The cathode current collector 109 is an aluminum foil. It comprises a strip-shaped main region, which is loaded with a layer of positive electrode material 110, and a free edge strip 109b, which extends along its first longitudinal edge 109a and which is not loaded with the electrode material 110. Both electrodes are shown individually in an unwound state.

The anode 105 and the cathode 108 are arranged offset from each other within the electrode-separator assembly 104, so that the first longitudinal edge 106a of the anode current collector 106 protrudes from the first terminal end face 104a and the first longitudinal edge 109a of the cathode current collector 109 protrudes from the second terminal end face 104b of the electrode-separator assembly 104. The offset arrangement can be seen in the illustration at the bottom left. The two ribbon-shaped separators 116 and 117, which separate the electrodes 105 and 108 from each other in the winding, are also shown there.

In the illustration at the bottom right, the electrode-separator assembly 104 is shown in wound form, as it can be used in an energy storage cell according to one of FIGS. 1 to 4. The electrode edges 106a and 109a protruding from the end faces 104a and 104b are clearly visible. The winding shell 104c is formed by a plastic film.

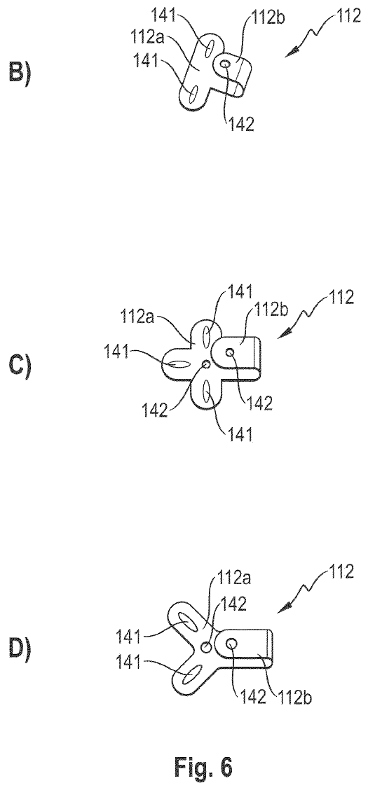

FIG. 6 shows further embodiments of the sheet metal component 112, which is suitable for contacting the first longitudinal edge 106a of the current collector 106 protruding from the first terminal end face 104a of an energy storage cell 100.

From the sheet metal components shown in embodiments B-D of FIG. 4, the embodiments B-D shown here differ essentially only in that the section 112b is not folded in a Z-shape but bent over in a U-shape. Such sheet metal components can replace the sheet metal component 112 and the electrical conductor 133 in the cells according to FIGS. 1 to 3.

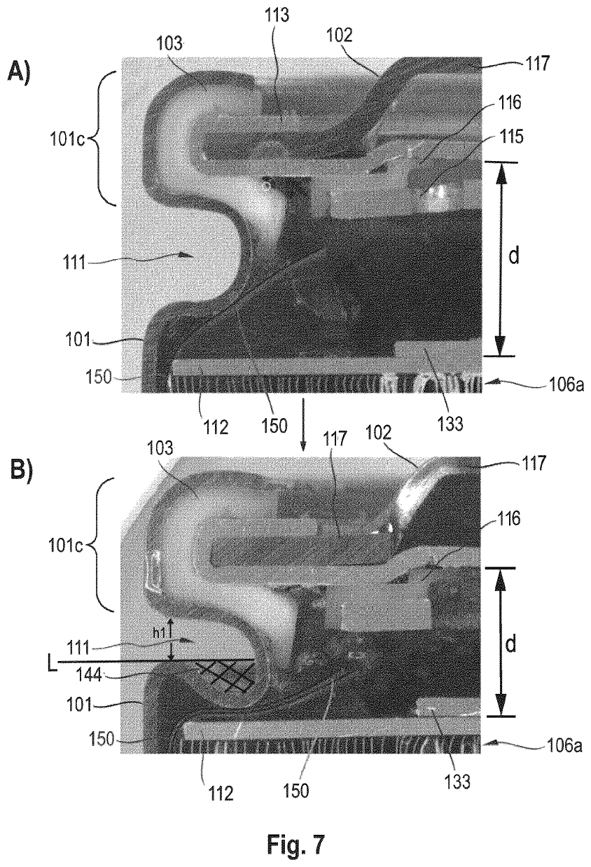

FIG. 7 shows photos of a longitudinal section through a preferred embodiment of an energy storage cell before (A) and after (B) a calibration process. To create the photos, the cells were cut lengthwise using a saw. An enlarged section is shown, which in particular shows details of the closure section 101c and the indentation 111.

The lid assembly 102 can be seen, comprising the metal disc 113, which is in electrical and direct contact with the pole cap 117, which closes off the lid assembly 102 on the outside. The edge of the metal disc 113 is folded over in a U-shape around the edge of the pole cap 117. The lid assembly 102 further comprises the metallic inner contact disc 115 and the insulator 116. The contact disc 115 is connected at the top by welding to a metallic membrane, which is not visible here and is integrated centrally in the metal disc 113, and at the bottom to the separate electrical conductor 133 (connection also not shown), which is welded to the sheet metal component 112. The sheet metal component 112 is in turn connected by welding to the first longitudinal edge 106a of the current collector protruding from the first terminal end face.

Before the calibration process, the indentation 111 is approximately symmetrical. An insulating tape 150 is applied to the edge of the sheet metal component 112 and protects it and the first longitudinal edge 106a from direct contact with the inner side of the housing cup 101. The insulating tape 150 protrudes upwards into a dead volume between the lid assembly 102 and the sheet metal component 112.

During height calibration, the closure section and the central section are pushed against each other by axial forces, with the closure section 101c and the central section 101b being pushed against each other under plastic deformation of the indentation 111, so that the distance d between the sheet metal component 112 and the lid component 102 becomes significantly smaller. This significantly reduces the dead volume between the lid assembly 102 and the sheet metal component 112. The plastic deformation of the indentation 111 can be clearly seen, which presses the insulating tape 150 almost onto the sheet metal component 112, whereby a short circuit through the insulating tape 150 is reliably avoided. Furthermore, an undercut 144 is formed by the deformation (hatched region below line L). Overall, as a result of the height calibration, the indentation has an annular opening slot with the height h1 and an annular cavity with the undercut 144 accessible via the opening slot.

After height calibration, the displayed cell has the format 21700.

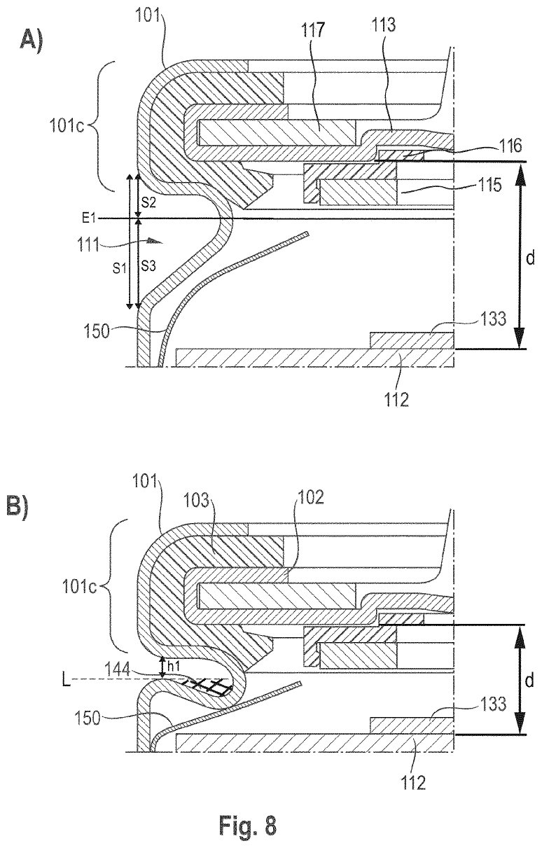

FIG. 8 shows a longitudinal section through another energy storage cell before (A) and after (B) a height calibration. An enlarged section is shown, which in particular shows details of the closure section 101c and the indentation 111.

The structure of the energy storage cell essentially corresponds to the cell shown in FIG. 7, with one significant exception: the indentation is asymmetrical before the height calibration. The housing of the energy storage cell is essentially cylindrical and the energy storage cell has a central axis that runs vertically through the bottom of the housing cup (not shown here). The housing cup has an identical maximum outer diameter in the central section 101b and the closure section 101c, while the outer diameter is reduced in the region of the indentation 111. A housing cup segment in which the outer diameter is reduced in the region of the indentation extends over a height S1. A plane E1, which is placed through the deepest point of the indentation and intersects the central axis perpendicularly, divides the housing cup segment into an upper part segment facing the lid component with a height S2 and a lower part segment facing the electrode-separator assembly with a height S3.

Due to the asymmetrical design of the indentation 111, S3 has a significantly larger value than S2. This enables advantageous deformation of the indentation 111 during height calibration.

It can also be seen here that the dead volume between the lid assembly 102 and the sheet metal component 112 is significantly reduced (see decrease in the distance d from A-->B). The plastic deformation of the indentation 111 can be clearly seen, which presses the insulating tape 150 almost onto the sheet metal component 112, whereby a short circuit through the insulating tape 150 is reliably avoided. Furthermore, an undercut 144 is also formed here by the deformation (hatched region below line L). Overall, as a result of the height calibration, the indentation also has an annular opening slot with the height h1 and an annular cavity with the undercut 144 accessible via the opening slot.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An energy storage cell, comprising:
an electrode-separator assembly with the sequence anode/separator/cathode, the anode being ribbon-shaped and comprising a ribbon-shaped anode current collector with a first longitudinal edge, a second longitudinal edge parallel thereto, a main region loaded with a layer of negative electrode material, and a free edge strip extending along the first longitudinal edge and being not loaded with the negative electrode material, the cathode being ribbon-shaped and comprising a ribbon-shaped cathode current collector with a first longitudinal edge and a second longitudinal edge parallel thereto, a main region loaded with a layer of positive electrode material, and a free edge strip extending along the first longitudinal edge and being not loaded with the positive electrode material, wherein the electrode-separator assembly is in the form of a cylindrical winding with a first terminal end face bounded by a circumferential edge and a second terminal end face bounded by a circumferential edge and a winding shell located therebetween, wherein the anode and the cathode are arranged within the electrode-separator assembly such that the first longitudinal edge of the anode current collector protrudes from one of the terminal end faces and the first longitudinal edge of the cathode current collector protrudes from the other terminal end face of the electrode-separator assembly;
an airtight and liquid-tight housing cup comprising a bottom and a terminal circular opening;
a lid component with a circular edge that closes the terminal circular opening;
wherein, in the housing cup, the electrode-separator assembly is arranged in axial alignment, with the first end face pointing towards the lid component and the second end face pointing towards the bottom, in certain cases being in direct contact with the bottom;
an annular seal made of an electrically insulating material, that encloses the circular edge of the lid component and electrically insulates the housing cup and the lid component from each other;
a sheet metal component connected by welding to a respective first longitudinal edge of a current collector protruding from the first terminal end face and wherein this current collector is electrically connected to the lid component via sheet metal component; and
at least one insulating element made of an electrically insulating material that protects the sheet metal component and/or the first longitudinal edge of the current collector protruding from the first end face and/or the separate electrical conductor fixed to the sheet metal component from direct contact with the inner side of the housing cup, in particular in the region of the indentation,
wherein the housing cup comprises an inner side and an outer side and, in axial sequence, a bottom, a central section and a closure section, wherein the central section is cylindrical and in the central section the winding shell of the electrode-separator assembly in the form of a winding is in contact with the inner side of the housing cup, and in the closure section, the annular seal is in press contact with the lid component and the inner side of the housing cup, and
wherein the central section and the closure section are separated by an indentation which annularly circumferentially surrounds the outer side of the housing cup.

2. The energy storage cell according to claim 1, wherein at least one of
the at least one insulating element is or comprises an insulating tape which is applied to the edge delimiting the end face and protects it from direct contact with the inner side;
at least one insulating element is or comprises an annular molded part made of plastic applied to the edge delimiting the end face and protecting it from direct contact with the inner side;
the insulating tape or the annular molded plastic part has a thickness in a range from 10 μm to 200 μm.

3. The energy storage cell according to claim 1, wherein at least one of:
the at least one insulating element is or comprises an annular insulating element made of plastic, which rests against the inner side of the housing cup in the region of the indentation and protects it from direct contact with the sheet metal component,.
the annular insulating element is a partial section of the annular seal;
the annular insulating element made of plastic has a thickness in a range from 50 μm to 500 μm.

4. The energy storage cell according to claim 1, wherein at least one of:
the at least one insulating element is or comprises an annular plastic part that encloses the sheet metal component and protects it from direct contact with the inner side of the housing cup in the region of the indentation;
the annular plastic part is hollow-cylindrical in shape, comprises a shell and is bounded on each end face by a circumferential edge;
the annular plastic part is hollow-cylindrical in shape, comprises a shell and is bounded at each end face by a circumferential edge, one of the edges being designed as an outwardly directed annular collar and resting on the sheet metal component;
the annular plastic part has a thickness in a range from 20 μm to 600 μm.

5. The energy storage cell of claim 1, wherein at least one of:
the at least one insulating element is or comprises an electrically insulating plastic coating which encloses an edge of the sheet metal component and protects it from direct contact with the inner side of the housing cup;
the electrically insulating coating is formed by overmolding the edge of the sheet metal component.

6. The energy storage cell of claim 1, wherein at least one of:
the at least one insulating element comprises an insulating tape or annular molded part made of plastic, which is applied to the edge delimiting the end face and protects it from direct contact with the inner side;
the at least one insulating element comprises an annular insulating element which rests against the inner side of the housing cup in the region of the indentation and protects it from direct contact with the sheet metal component;
the at least one insulating element comprises an annular plastic part that encloses the sheet metal component and protects it from direct contact with the inner side of the housing cup in the region of the indentation;
the at least one insulating element is or comprises an electrically insulating plastic coating which encloses an edge of the sheet metal component and protects it from direct contact with the inner side of the housing cup.

7. The energy storage cell according to claim 1, wherein at least one of:
the housing cup has an identical maximum outer diameter in the central section and the closure section;
in the region of the indentation, the outer diameter of the housing cup is reduced by 4 to 12 times the wall thickness of the housing cup in this region.

8. The energy storage cell according to claim 1, wherein at least one of:
the sheet metal component is directly connected to the lid component;
the sheet metal component comprises a first section which rests flat on the first longitudinal edge of the current collector protruding from the first terminal end face and extends parallel to the end face;
the sheet metal component comprises a second section which adjoins the first section at an angle and via which the first section is electrically connected to the lid component.

9. The energy storage cell according to claim 1, wherein at least one of:
the sheet metal component is connected to the lid component via the separate electrical conductor;
the sheet metal component rests flat on the first longitudinal edge of the current collector protruding from the first terminal end face.

10. The energy storage cell according to claim 1, wherein at least one of:
the first longitudinal edge of the current collector protruding from the second terminal end face rests directly on the bottom of the housing cup and is connected to it by welding ;
the cell comprises a sheet metal component which is connected by welding to the first longitudinal edge of the current collector protruding from the second terminal end face and via which this current collector is electrically connected to the bottom of the housing cup.

11. The energy storage cell according to claim 1, wherein the current collector protruding from the first terminal end face is the anode current collector and the current collector protruding from the second end face is the cathode current collector.

12. The energy storage cell according to claim 1, wherein at least one of:
the housing cup consists of aluminum or an aluminum alloy; and/or
a terminal section of a current collector foil comprising aluminum or an aluminum alloy, not coated with electrode material, forms the outer turn of the winding and at the same time rests directly against the housing cup made of the aluminum or the aluminum alloy.

13. The energy storage cell according to claim 1, wherein at least one of:
the housing cup comprises copper or nickel or a copper or nickel alloy; and/or
a terminal section of a current collector foil comprising copper or nickel or a copper or nickel alloy, not coated with electrode material, forms the outer turn of the winding and at the same time rests directly against the housing cup made of the copper or nickel or the copper or nickel alloy.

14. A method of manufacturing an energy storage cell comprising the following steps:
providing an energy storage cell according to claim 1;
subjecting the energy storage cell to a height calibration, wherein the closure section and the central section are pushed against each other under plastic deformation of the indentation, so that a distance d between the sheet metal component, which is connected to the respective first longitudinal edge by welding, and the lid component is reduced.

15. The method according to claim 14, wherein the distance d between the sheet metal component and the lid component is reduced by at least 10 %.
